(19) United States
(12) Patent Application Publication
(10) Pub. No.: US 2017/0352158 A1
(43) Pub. Date: Dec. 7, 2017

(54) SYSTEMS AND METHODS FOR INTERPRETATION OF MEDICAL IMAGES

(71) Applicant: Reads for Rads, Inc., New York, NY (US)

(72) Inventor: Anup Raina, Malvern, PA (US)

(73) Assignee: Reads for Rads, Inc., New York, NY (US)

(21) Appl. No.: 15/615,918

(22) Filed: Jun. 7, 2017

Related U.S. Application Data
(60) Provisional application No. 62/347,013, filed on Jun. 7, 2016.

(51) Int. Cl. G06T 7/00; H04N 19/162; H04N 19/102; H04N 19/17; H04N 1/21; G06F 19/00

(52) U.S. Cl. CPC G06T 7/0012; H04N 1/217; G06F 19/3418; G06F 19/324; H04N 19/102; H04N 19/17; H04N 19/162; G06F 19/321

(57) ABSTRACT

Systems, methods and applications for a system for obtaining a medical interpretation for medical images include a customer portal where a customer uploads one or more medical images and accesses a marketplace for obtaining the medical interpretation, where a medical case includes one or more medical images. The system also includes an image service provider portal where a medical imaging expert accesses the medical case and provides the medical interpretation. Further, the system includes a back-end server that stores the medical case and acts as a communication conduit between the customer and the medical imaging expert.

### BACKGROUND

Rapid advancements in imaging technology have changed the work of medical professionals, such as radiologists and pathologists. For example, radiologists were previously confined to reading limited number of projected images, such as musculoskeletal radiographs. With advances in imaging technology, radiologists may be reading thousands of images in the Computed Tomography (CT) scan of multiple body parts in a patient with multiple trauma. Thus, the amount of data in medical images that have to be interpreted by medical imaging experts is increasing.

Particularly, due to the falling costs of high-quality scanning devices, there has been a proliferation of these devices at many outpatient and remote medical settings, which were once only available in hospital and throughput imaging clinics. Advances in technology also has proliferated the digitization of medical records and medical images, which may allow storage, transfer and access of data across multiple platforms and regions. Advances in data management and artificial intelligence have provided new tools for handling and processing of large amount of medical images.

With the increase in imaging data, there may be demand surges beyond the capacity for medical interpretation that can be accomplished by local medical experts, particularly in times of acute crisis or a common holiday. Thus, medical imaging expertise from different localities may be leveraged to meet demand surges.

Leveraging advances in technologies and providing a platform for medical imaging experts and other stakeholders in the health care system may lead to high-quality medical interpretation at lower costs, which in turn will lead to better outcomes for the patient and increase efficiencies in the health care system.

### SUMMARY OF THE EMBODIMENTS

A system for obtaining a medical interpretation for medical images includes a customer portal wherein a customer uploads one or more medical images, wherein one or more medical images comprise a medical case. The system may also include an image service provider portal wherein a medical imaging expert accesses the medical case and provides the medical interpretation. Further, the system may include a back-end server that stores the medical case, provides access to a marketplace for obtaining the medical interpretation and acts as a communication conduit between the customer and the medical imaging expert.

The system may also include one or more databases for storing the medical images. The medical images may be uploaded by routing them via a Direct Connect (DC) Gateway. The credentials of the medical imaging experts may be checked when they login to the image service provider portal. The medical image service provider may have been on-boarded onto the system by verification of one or more credentials. The medical case may also be assigned to one or more medical imaging experts automatically using a matching algorithm comprising machine learning techniques. Or the medical case may be assigned to one or more medical imaging experts using a matching algorithm.

In further embodiments, the medical imaging expert who has accepted the medical case may have secure communications in real-time with the customer requesting the medical interpretation. In further embodiments, the server creates a knowledge base based on medical images uploaded to the system over time. In further embodiments, the system allows customers to review medical imaging experts. In further embodiments, the system further comprises a bidding engine that allows customers to bid on the services of medical imaging experts. In further embodiments, the system includes a malpractice component wherein the malpractice insurance is provided on a per case basis for the services of the medical imaging experts.

In another aspect, a process for obtaining a medical interpretation for medical images is disclosed. The process includes the steps of: (a) a customer uploads one or more medical images through a customer portal and accesses a marketplace for obtaining the medical interpretation of the medical images, wherein one or more medical images comprise a medical case; (b) a medical imaging expert with verified credentials accesses the medical case through a medical image service provider portal and provides the medical interpretation; and (c) a report is generated in a back-end server based on the medical interpretation provided by the medical imaging expert and shared with the customer.

In further embodiments, the process includes storing the medical images in one or more databases in the back-end server. In further embodiments, the medical images are uploaded by routing them via a Direct Connect (DC) Gateway and stored in one or more databases in the back-end server. In further embodiments, the system includes a Transactional Database for storing medical images uploaded through a router. The system may include a Reporting Database for creating and storing reports of medical interpretation or a database management system for storing expert profiles, medical cases, medical reports, payments, etc. A medical imaging expert who has accepted the medical case may be able to request access to priors comprising prior medical images of the same patient, and the system may automatically identify these prior medical images in the system.

The medical images may conform to the Digital Imaging and Communications in Medicine (DICOM) standard and provide access to third-party medical clouds. The system may include an administrator portal wherein administrator provides oversight over the system. The system may add exemplary medical cases and reports to the knowledge base and allows medical imaging experts to review customers such as imaging centers.

In some instances, the customer is a patient seeking a second opinion or a health care service provider, an imaging center, an ambulatory surgical center, a hospital or hospital system, a health center, etc.

The medical imaging expert who has accepted the medical case may have secure communications in real-time with the customer requesting the medical interpretation. A knowledge base based on medical images in the back-end system may be formed over time, and the back-end server may allow customers to review medical imaging experts. The system may include a bidding process for customers to bid on the services of medical imaging experts and the system may verify the credentials of the medical imaging expert by checking primary sources.

A non-transitory computer readable medium may have a series of instructions that, when executed by a processor, cause the processor to execute instructions that allow: (a) a customer to upload one or more medical images through a customer portal, wherein one or more medical images comprise a medical case; (b) a medical imaging expert with verified credentials to access the medical case through a medical image service provider portal and provide the medical interpretation; and (c) a report to be generated in a back-end server based on the medical interpretation provided by the medical imaging expert and shared with the customer.

A system for credentialing medical imaging experts may include an image service provider portal wherein a medical imaging expert initiates the credentialing process by providing profile information comprising one or more credentials. The system may also include an administrative portal wherein an administrator manages the credentialing process and obtains verification record of the credentials of the medical imaging experts. The system may also include a back-end server that stores the profile information and verification record of the medical imaging experts, wherein the back-end server comprises a medical passport module for on-boarding medical imaging experts by verification of one or more credentials.

The credentials of the medical imaging experts may be checked when they log-in to the image service provider portal. These medical imaging experts may be available to provide final medical interpretations of medical images after on-boarding by verification of one or more credentials. The medical imaging experts who have been on-boarded may access medical cases to provide medical interpretations wherein medical cases may be searched based on types of medical tests, types of images, modalities, price, region, health insurance, health systems, health care service providers, subspecialties, reading time windows, etc. A customer may view the credential verification status of one or more credentials of medical imaging experts before providing medical images for medical interpretation. The step of obtaining a verification record may include a status check of the professional licensing, board certifications, or state licensing of the medical imaging expert,

The step of obtaining a verification record may be completed by an independent third-party by verifying primary sources for the credentials of the medical imaging experts. The step of obtaining a verification record may be completed by the medical imaging expert or image service provider by uploading documentation of the verification record and the step of obtaining a verification record may comprise manual review by the administrator. The administrator may override the step of obtaining a verification record in a limited number of situations. The system may include one or more devices of the medical imaging expert for receiving notifications from the system. The system may also include profiles of medical imaging experts comprising information from one or more categories comprising years of experience, total reads provided, types of reads provided, contribution to the knowledge base, examples of cases read including reports (without the PHI), credential verification status, verified account, institution, specialty and/or subspecialty. Profile information of the medical imaging expert may include sections on demographics, education, work, sanctions. In further embodiments, wherein the medical imaging experts comprise radiologists and subspecialties comprise musculoskeletal, breast, thoracic, neuroradiology, pediatric, abdominal, cardiac, cardiovascular, emergency, gastrointestinal, head and neck, internal medicine, obstetric/gynecologic, oncologic imaging, vascular imaging, research, etc.

The medical imaging experts may include individual radiologists, a group of radiologists, academic radiologists, etc. In further embodiments, the medical imaging experts comprise radiologists, pathologists, physical therapists, etc. The system may include a bidding engine that allows medical imaging experts to bid on the task of reading medical images. The price for services may be fixed based on factors such as type of reading, medical expert's time, expert's certifications and/or seniority, region, health system, etc. The medical imaging experts may provide readings of medical images for educational or training purposes. The system may include a malpractice component where the malpractice insurance is provided on a per case basis for the services of the medical imaging experts.

A marketplace for obtaining medical interpretation for medical images may include a customer portal wherein a customer uploads one or more medical images, wherein one or more medical images comprise a medical case. The marketplace may include an image service provider portal wherein a medical imaging expert accesses the medical case comprising medical images and provide medical interpretation. The marketplace may include a payment gateway wherein a payer pays for the medical interpretation and a back-end server that stores the medical case and acts as a communication conduit between the customer and the medical imaging expert. The medical interpretations may be bid upon by customers. The payer may be a health insurance company, which pays for the partial cost of the medical interpretation. The customer may be associated with one or more tax IDs, National Payer Identifier (NPI), Medicare ID, Medicaid ID, medical health plans, etc., which may have to be provided before enrolling in the marketplace. The payer may be enrolled onto the marketplace by providing payment information. The payment gateway may belong to a third party such as PayPal, Braintree, BitPay, etc. The marketplace may include medical imaging experts from various regions of the world and recommends a price for the medical interpretation.

### BRIEF DESCRIPTION OF THE DRAWINGS

Embodiments of the present invention are described with reference to the following drawings for exemplary purposes only. In the drawings, like reference numerals refer to like parts throughout the various figures unless otherwise specified.

For a better understanding of the presently disclosed subject matter, reference will be made to the following Detailed Description, which is to be read in association with the accompanying drawings, wherein:

FIG. 1 is an illustration of the system for obtaining a medical interpretation for medical images;

FIGS. 2A and 2B show exemplary screenshot for registration or sign-up for an medical imaging expert and customer;

FIG. 3 shows an exemplary screenshot for uploading images;

FIG. 4 shows an exemplary screenshot of the customer's home page;

FIG. 5 shows an exemplary screenshot of the customer's medical case;

FIG. 6 is an illustration of a system for marketplace for obtaining medical interpretation for medical images;

FIG. 7 depicts the relationships that various third parties may have with the back-end server 720;

FIG. 8 shows an exemplary screenshot of the search screen for medical image service providers or medical imaging experts;

FIGS. 9A and 9B show exemplary screenshots of a medical imaging expert's profile;

FIGS. 10A and 10B show an exemplary screenshots for searching for medical image service providers or medical imaging experts and saving favorites;

FIGS. 11A and 11B show exemplary screenshots for reviewing;

FIG. 12 shows an exemplary screenshot of a medical imaging expert or provider's home screen;

FIGS. 13A and 13B shows exemplary screenshots of a medical imaging expert or provider's medical cases;

FIGS. 14A, 14B, 14C, 15A and 15B depict exemplary screenshots for providing medical interpretations;

FIG. 16 shows an exemplary screenshot of prior studies; and

FIGS. 17A and 17B show an exemplary screenshots for credential management.

### DETAILED DESCRIPTION

### Introduction

The system may allow health professionals and patients with diagnosis, prognosis, and treatment planning for diseases and has the potential to advance the state of computational pathology by making it more accurate and efficient than current techniques. To aid personalized treatments and precision medicine, determination of specific sub-types and combinations of sub-types of cancers in patients based on their causes or likely future course may be necessary.

The disclosed systems and methods aim to provide the high-quality medical imaging interpretation services to the customer by allowing the customer to access a pool of medical experts, who may be located in different parts of the world. In some cases, the medical experts may not be accessible to the customer because he or she is affiliated with academic institutions and/or hospitals and health systems outside the customer's insurance plan or health system. Previously, medical imaging experts did not have an easy-to-use platform for communicating with customers and interact with them in real-time to provide medical interpretation services.

The systems and processes relate to obtaining a medical interpretation for medical images. The system may include a customer portal wherein a customer uploads one or more medical images, wherein one or more medical images comprise a medical case. The system may also include an image service provider portal wherein a medical imaging expert accesses the medical case and provides the medical interpretation. Further, the system may include a back-end server that stores the medical case and acts as a real-time communication conduit between the customer and the medical imaging expert.

In another aspect, a non-transitory computer readable medium may have a series of instructions that, when executed by a processor, cause the processor to conduct a series of steps for obtaining a medical interpretation of medical images. These instructions may be designed to provide an easy-to-use platform for secure communications between medical imaging experts and customers in real-time.

Systems and methods for credentialing medical imaging experts for providing medical interpretations of images may include a credential verification process that will allow verification of one or more credentials of the expert from primary sources. In some embodiments, the experts may have credentials from different parts of the world. The customers may not even be familiar with the credentials and may not be able to verify an expert's credentials.

A marketplace for obtaining medical interpretation for medical images may include customers, such as patients, imaging centers, hospitals, health systems, etc., who may not be able to access information about imaging experts and bid on expert medical services. In addition, medical experts may be able to provide their services directly to customers and receive direct payments through the system.

Various medical techniques lead to the creation of medical images, which may be interpreted by medical imaging experts, such as radiologists and pathologists, for diagnosis, treatment or prevention of diseases and conditions. For example, medical imaging may be used for treatment of an injury to a body organ or diseases, such as cancers.

Medical images may refer to images of a patient's body including skeletal structure, muscular structures, organs, blood vessels, lymph nodes, nerves, tissues, cells, etc., used for diagnosis and treatment of a medical condition, injury or disease. In some cases, the medical images may be X-ray or CT radiographs.

Medical images may be generated from numerous medical techniques and procedures including X-ray scans, computed tomography (CT) scans, mammograms, molecular imaging techniques, ultrasounds, magnetic resonance imaging (MRI), tactile imaging, medical photography, nuclear medicine imaging such as positron emission tomography (PET) and single-photon emission computed tomography (SPECT), Electroencephalography (EEG), magnetoencephalography (MEG), electrocardiography (ECG), etc.

X-rays may include digital images of internal composition of a material, such as a part of the human body, produced by X-rays being passed through the material. As referenced herein, “computed tomography (CT) scan” may include to use of computer-processed combinations of X-ray images taken from different angles to produce cross-sectional (tomographic) images of specific areas of a scanned object. A “mammogram” may refer to an X-ray picture of the breast. Screening mammography may include the type of mammogram that checks in cases of no symptoms.

Molecular imaging may provide detailed pictures of what is happening inside the body at a molecular and cellular level. For example, ultrasound imaging (sonography) uses high-frequency sound waves to view inside the body. Because ultrasound images are captured in real-time, they can also show movement of the body's internal organs as well as blood flowing through the blood vessels. In addition, magnetic resonance imaging (MRI) is a medical imaging technique used in radiology to form pictures of the anatomy and the physiological processes of the body in both health and disease. MRI scanners may use strong magnetic fields, radio waves, and field gradients to generate images of the organs in the body.

Tactile imaging may provide an imaging modality translating the sense of touch into a digital image. For example, medical photography may document clinical presentation of patients, medical and surgical procedures, medical devices and specimens from autopsy.

Nuclear medicine imaging may use small amounts of radioactive materials called radiotracers that are typically injected into the bloodstream, inhaled or swallowed. The radiotracer travels through the area being examined and gives off energy in the form of gamma rays which are detected by a special camera and a computer to create images of the inside of the body. Nuclear medicine imaging provides unique information that often cannot be obtained using other imaging procedures and offers the potential to identify disease in its earliest stages. For example, PET refers to a nuclear medicine functional imaging technique that is used to observe metabolic processes in the body. SPECT or less commonly, SPET is an imaging technique using gamma rays.

EEG is an electrophysiological monitoring method to record electrical activity of the brain. It is typically noninvasive, with the electrodes placed along the scalp, although invasive electrodes are sometimes used in specific applications. EEG measures voltage fluctuations resulting from ionic current within the neurons of the brain. MEG is a functional neuroimaging technique for mapping brain activity by recording magnetic fields produced by electrical currents occurring naturally in the brain, using very sensitive magnetometers. The echocardiogram uses ultrasound, or echoing high-frequency sound waves, to create a visual image of the heart, which helps doctors view the internal structure of a patient's heart and how well blood is able to flow through it.

Various medical imaging experts or medical image service providers may include radiologists, pathologists, cytologists, microbiologists, hematologists. Radiologists provide medical interpretation for medical images from X-ray and other high-energy radiation techniques. There are various specialties and subspecialties of radiology including diagnostic radiology, which in turn includes subspecialties in hospice and palliative medicine, neuroradiology, nuclear radiology, pain medicine, pediatric radiology, vascular and interventional radiology. A diagnostic radiologist uses X-ray, radionuclides, ultrasound, and electromagnetic radiant to diagnose and treat diseases. Other specialties in radiology include interventional radiology or diagnostic radiology, which in turn includes subspecialties of hospice and palliative medicine, neuroradiology, pain medicine, pediatric radiology. An interventional radiologist combines imaging, image-guided minimally invasive procedures and periprocedural patient care to diagnose and treat conditions of the thorax, abdomen, pelvis and extremities. Other radiology specialties include radiation oncology with subspecialties in hospice and palliative medicine and pain medicine. A radiation oncologist uses ionizing radiation and other modalities to treat diseases.

Pathologists diagnose diseases based on the laboratory analysis of bodily fluids such as blood and urine, as well as tissues, using the tools of chemistry, clinical microbiology, hematology and molecular pathology. Cytologists study cellular diseases and the use of cellular changes for the diagnosis of diseases. Microbiologists investigate the growth, interactions and characteristics of microscopic organisms such as bacteria, algae, fungi, and some types of parasites and their vectors. Hematologists study the cause, diagnosis, treatment, and prevention of diseases related to blood.

There are public and private databases where the credentials of medical imaging experts and providers can be found and searched. A primary source for the certification status of certified physicals is available on the website of the American Board of Radiology where a physician's credentials may be searched by last name. For example, medical professional licensing status in the State of California may be found on their web site.

Many health systems have integrated electronic medical records (EMRs) through commercial offerings, such as PrimeSuite, Genesis Chiropractic Software, Allscripts Professional HER, iPatientCare HER, SoftClinic, Aprima Medical Software.

There are several laws and regulations for health care providers and systems. For example, HIPAA (Health Insurance Portability and Accountability Act of 1996) provides data privacy and security provisions for safeguarding medical information. The Administrative Simplification Compliance Act (ASCA) prohibits payment of services or supplies that a provider did not bill to Medicare electronically.

Providers may include physicians, suppliers, and other health care providers. Providers are required to self-assess to determine whether they meet certain permitted exceptions to this electronic billing requirement. The Patient Safety and Quality Improvement Act of 2005 (PSQIA) establishes a voluntary reporting system designed to enhance the data available to assess and resolve patient safety and health care quality issues.

There are numerous medical or health insurance plans that cover health care services. In some cases, certain services and procedures are covered differently within a preferred network or health system.

Medical professional liability insurance, sometimes known as medical malpractice insurance, refers to one type of professional liability insurance which protects physicians and other licensed health care professionals (e.g., dentist, nurse) from liability associated with wrongful practices resulting in bodily injury, medical expenses and property damage, as well as the cost of defending lawsuits related to such claim.

A back-end server may refers to a proprietary computer program that provides services to other services or computer programs in the same or other computers. The server application may be distributed on various computers in remote locations, also referred to as a remote server. An application server may include a program in a computer or distributed network that provides the business logic or layer for an application. Static Web Applications are developed in HTML and CSS but these are not the only platforms to develop the static applications. jQuery and Ajax are alternatives that can also be considered. Animated objects, such as banners, GIFs, videos, etc., can be displayed in the static application easily. Dynamic web applications may use databases for data loading and its contents are updated each time the user accesses them and include an administration panel (called CMS), where administrators can correct or modify application content, whether text or images. Different programming languages can be used for the development of dynamic web applications. PHP and ASP are the most common languages used for this purpose because they allow the structuring of contents.

A portal web application may include an application that accesses the various sections or categories through a home page. These applications can include many things: forums, chats, e-mails, browsers, areas accessed through registration, the latest content, etc.

Animated web applications may include animations with Flash or other technology. This programming approach allows a user to display content with animated effects. This type of application allows more creative and modern designs and is one of the key technologies used by designers and creative directors.

### DESCRIPTION

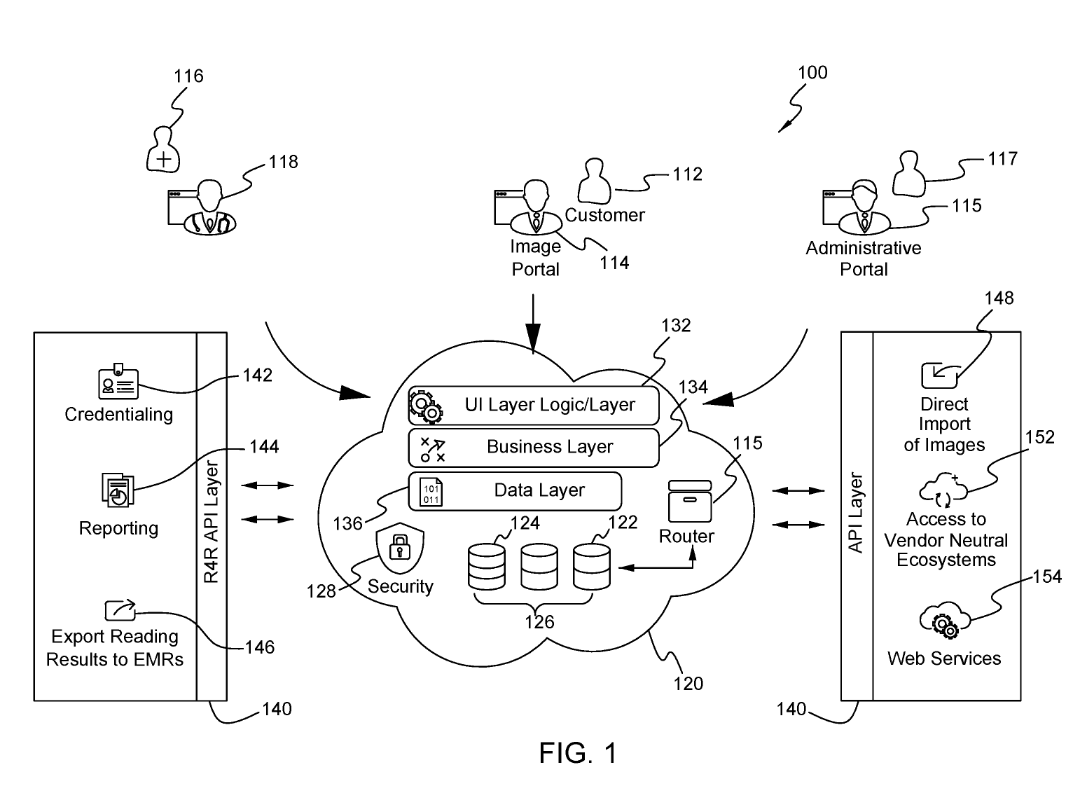

FIG. 1 is an illustration of the system for obtaining a medical interpretation for medical images. Within the system 100, customers 112 may use the image portal 114 to upload and download files, such as images, reports, receipts, etc.

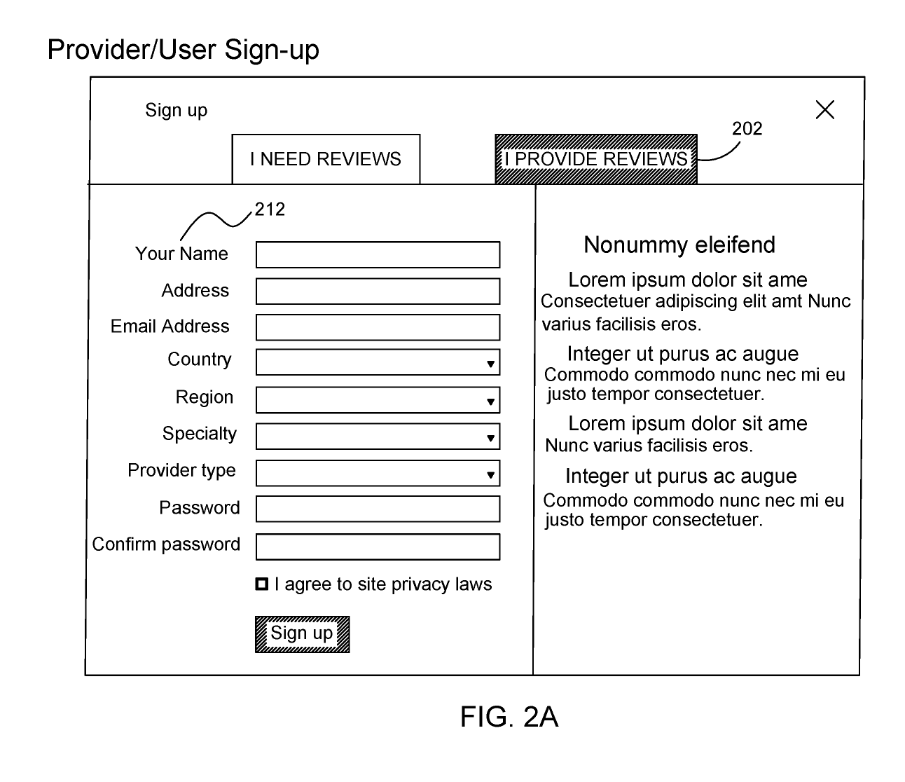

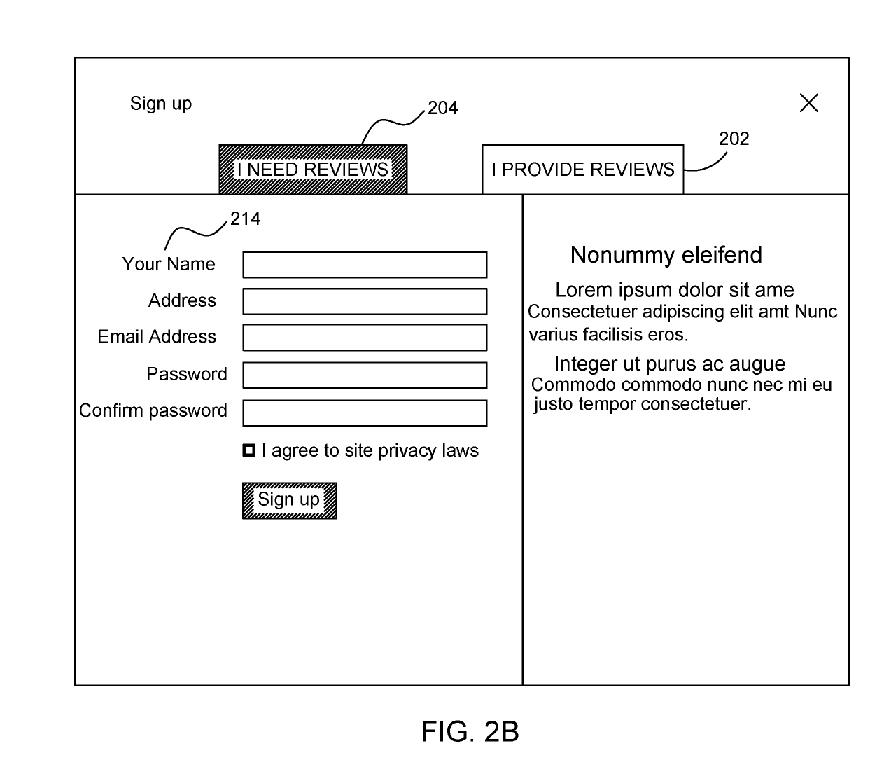

A customer 112 may be required to register themselves by enrolling onto the system 100 through registration process. Thus, access to the system 100 can be restricted to customer 112, for example, by issuing a login and password after the customer has provided sufficient information. An exemplary registration or sign-up screen is shown in FIG. 2B for a customer 112. As shown in FIG. 2B, the customer can choose tab “I Need Reviews” tab 204 and insert case information 214 (including name, address, email, password, etc.). Alternately as shown in FIG. 2A, a medical imaging expert or provider can choose “I Provide Reviews” tab 202 and insert expert information 212 (including name, address, email, country, region, specialty, provider type, password, etc.).

The portals 114, 115, and 118 may interface with various applications in the API layer 140, which may include credentialing of experts 142, reporting of medical interpretations 144, exporting reading results to client electronic medical records (EMRs) 146, direct import of images 148, access to vendor neutral ecosystems 152 (such as Philips, Samsung, Siemens, GE health clouds), other web services 154 (such as Amazon, Microsoft, Google web services).

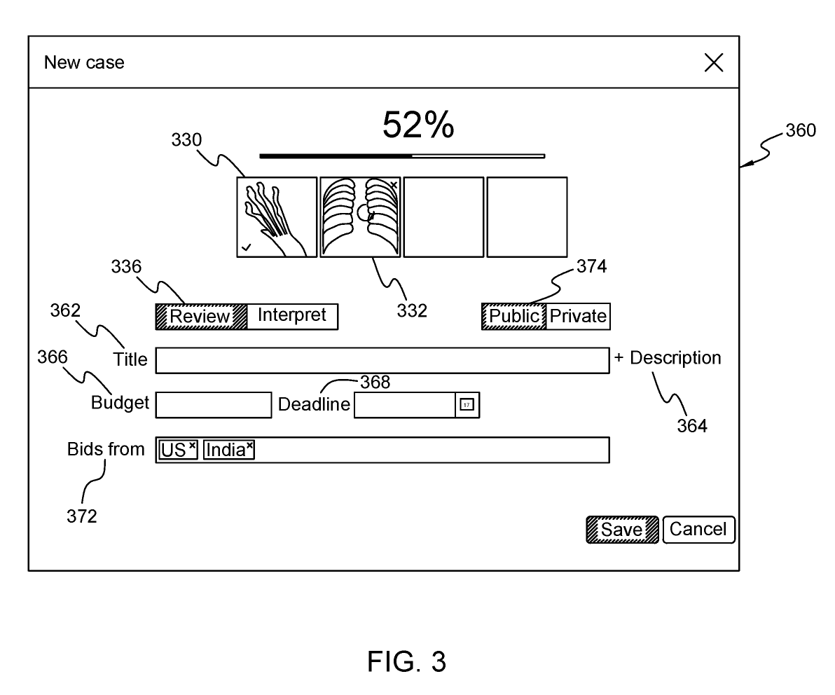

In some embodiments, the customer 112 uploads medical images after logging-in to system 100 using a secure login and password. An exemplary image uploading screen is shown in FIG. 3. As shown, the images 330, 332, comprise a medical case 360 and can be uploaded the exemplary screen. The customer may upload the images 330, 332 to a back-end server through an imaging portal. The customer 312 may specify a title 362, description 364, budget 366, deadline 368, types of reading 336 (review or interpret), etc. A “review” may be a second opinion or a quality assurance (QA) of a reading that has been done by another expert and may include a comparative analysis. An “interpret” may refer to medical interpretations of an unread medical image. As shown, the customer may solicit public or private bids (using buttons 374) from medical experts from specified regions of the world in box 372. The public bids may be available to all medical imaging experts in the system while “private bids” may be offers that are made to a selected group of medical imaging experts, such as based on specialties and subspecialties, review ratings, location, etc.

Referring to FIG. 1, medical imaging experts 116, such as radiologists or pathologists, may access the server 120 through an image service provider portal 118. The expert 116 may sign-in using an exemplary screen shown in FIG. 2A.

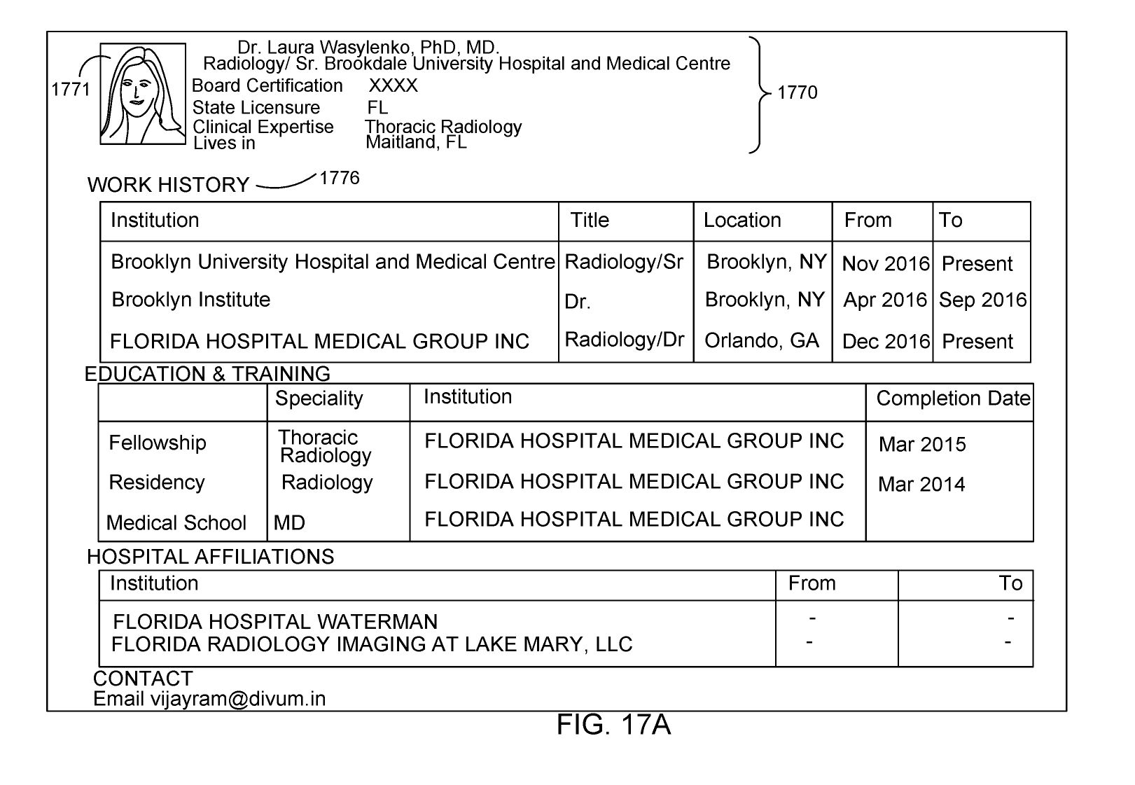

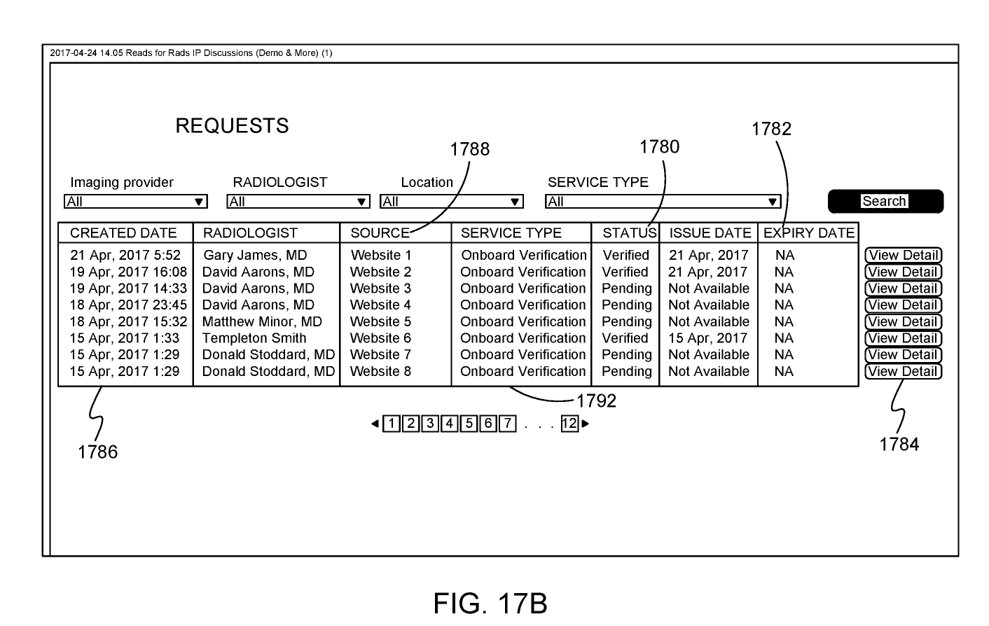

In some embodiments, the experts 116 may have to be on-boarded onto the system 100 by credential verification before being allowed to provide medical interpretations, particularly “final” medical interpretations. In some embodiments, final readings are medical interpretations for which the medical imaging experts have electronically signed the report and system has saved an audit trail. Further details regarding the credential verification process is described in relation to FIGS. 17A and 17B.

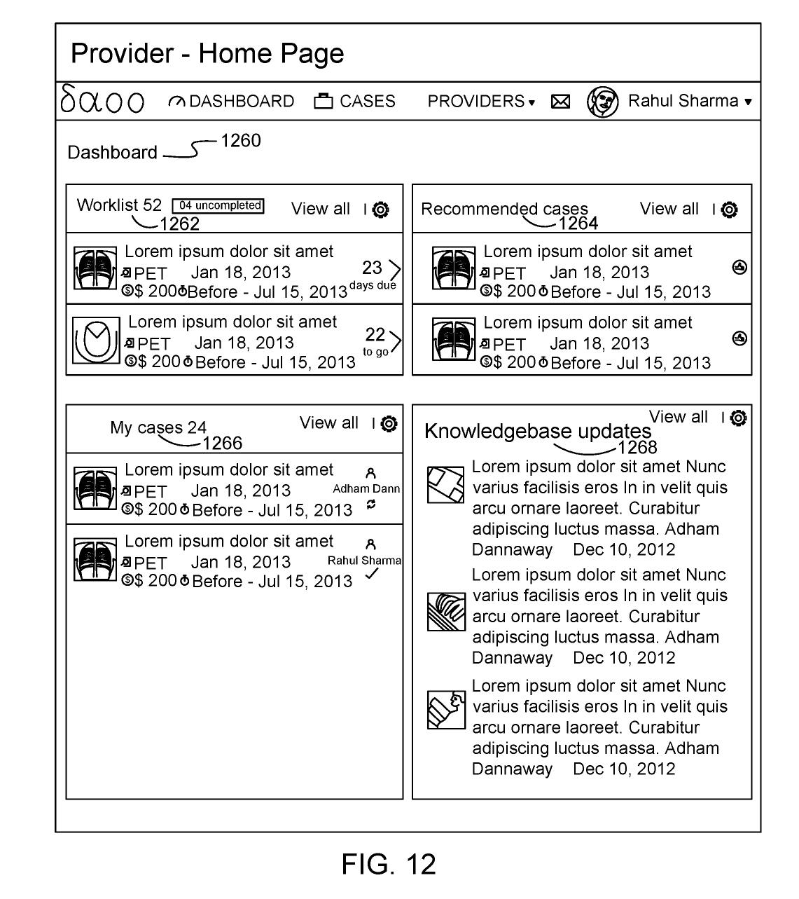

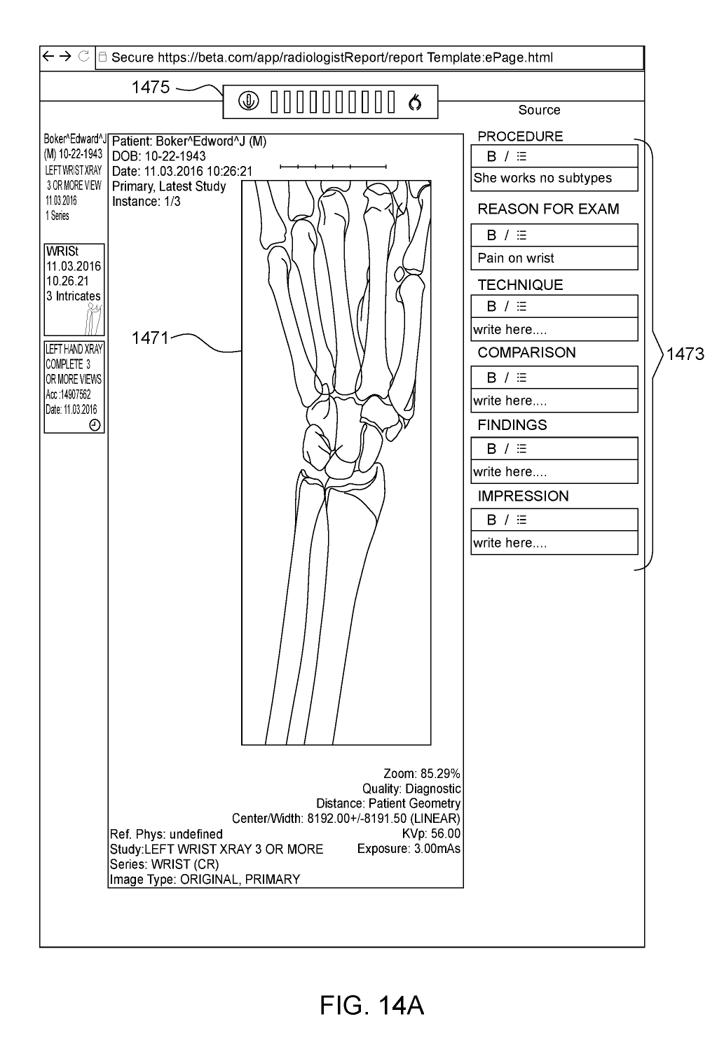

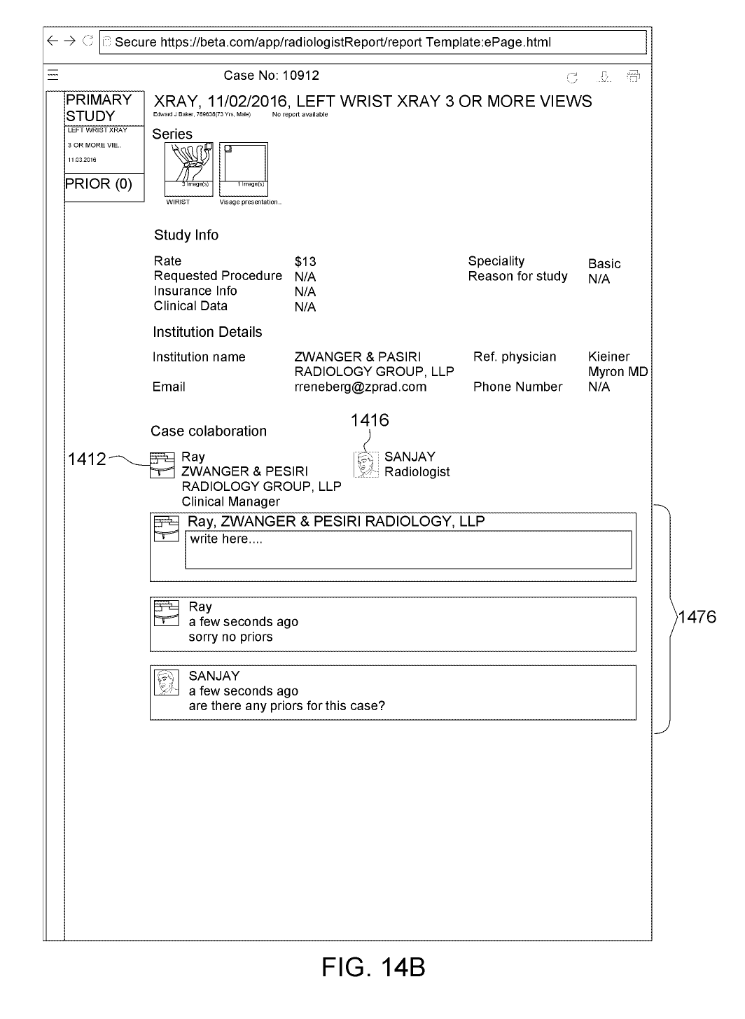

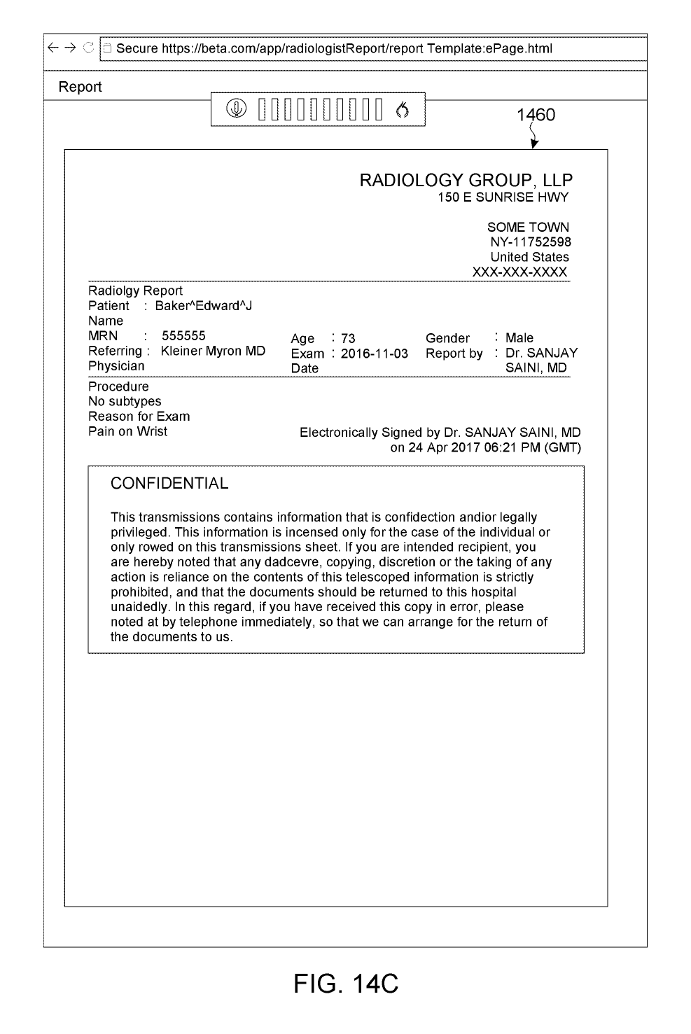

Once an expert 116 has logged on to the image service provider portal 114, they may be able to view medical cases and other materials (e.g., screen shown in FIG. 12). The expert 116 may view the medical case including one or more medical images 330 using an image viewer such as a DICOM viewer (e.g. screen shown in FIG. 14A). The expert 116 may provide medical interpretations using report template (e.g. shown in FIG. 14B).

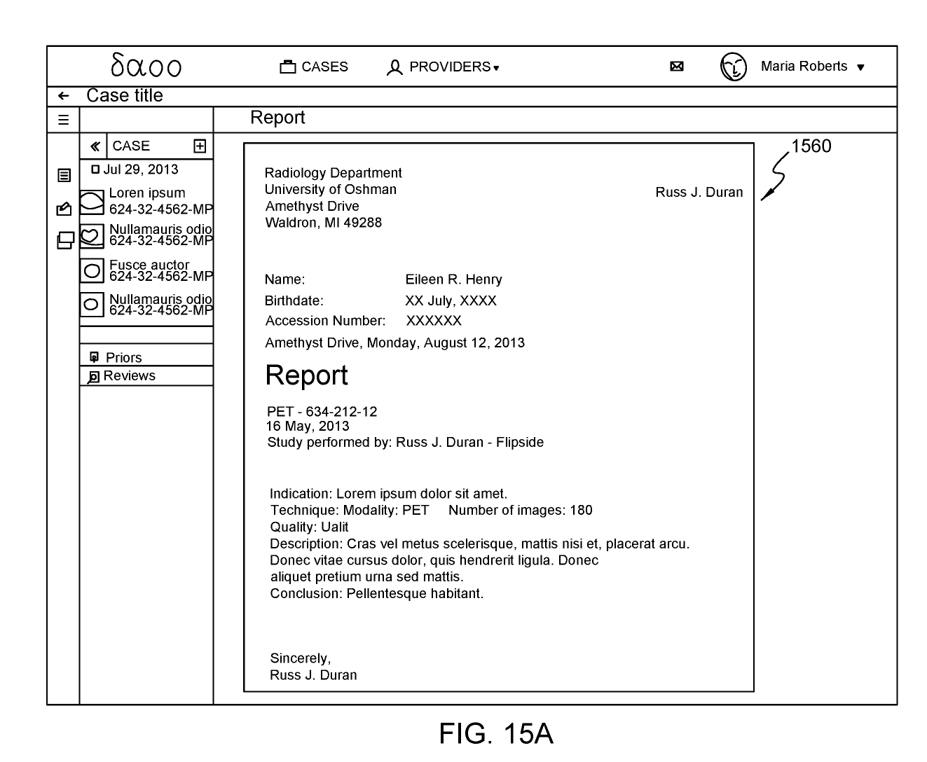

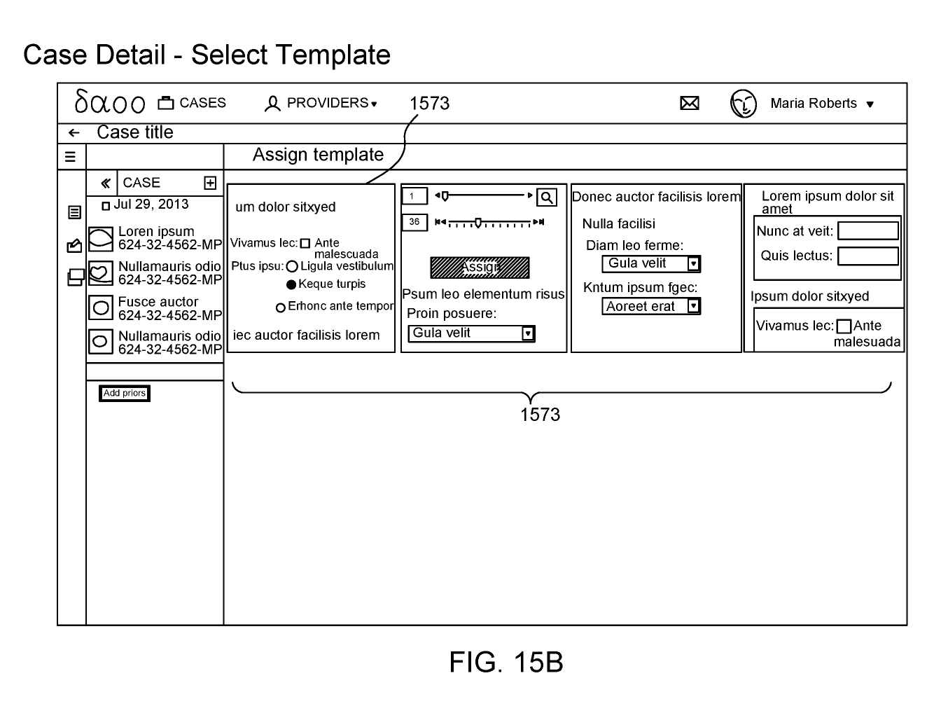

The medical interpretation may be reported in various ways. In some embodiments, one or more reports are generated. Exemplary reports are shown in FIGS. 14C and 15A. The medical interpretation may be exported to the customer's electronic medical records (EMRs) through the Exporting Reading Results API 146. The medical interpretation may be provided to the customer in an email or other form of notification.

Health care administrators 117 may provide oversight to the server 120, including the credential management system. An administrator 117 may access the system 100 through an administrator portal 119. The administrator 117 may supply and retrieve various documents from the server 120 pertaining to billing, credentialing, reviews, medical cases, medical reports, etc.

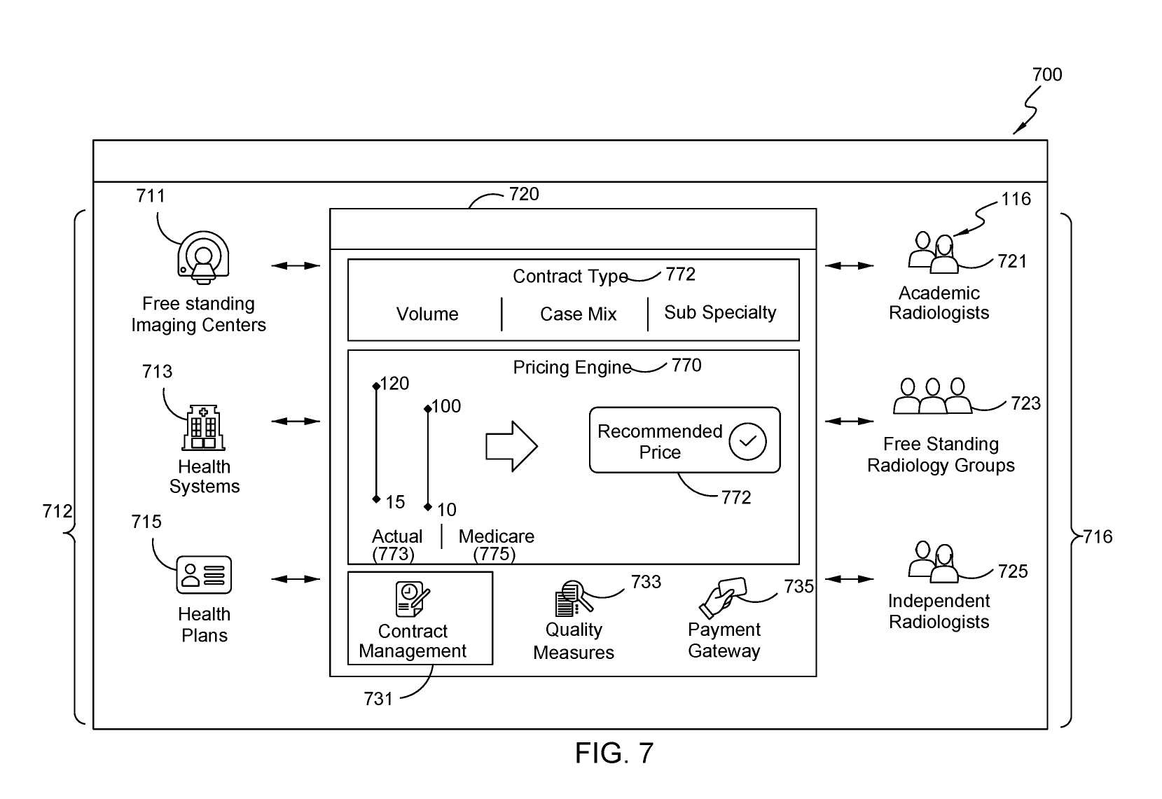

The server 120 may include several layers with specific functions and responsibilities including a user interface (UI) logic or layer 132, a business logic or layer 134, and a data layer 136. The UI layer 132 may be responsible for various consumer interactions. The business layer may control the business aspects of the server 120 such as the pricing engine (e.g. depicted in FIG. 7). The data layer manages the data storage and distribution in the server 120.

The server 120 may also include a security system, databases 126 including patient databases 122 and provider databases 126. The server 120 may communicate with data sources via a router 115 or other communications means.

The server 120 may provide a mechanism for third parties to interact with the server 120, e.g., via an API layer. For example, third parties may be involved in credentialing of experts, communicating medical interpretations, validating reports, or for providing other healthcare ecosystems, which will allow the server 120 to provide additional functionality such as access to longitudinal patient records (e.g. EMRs), voice dictation systems, standardized reporting templates, billing systems, health care data aggregators, etc. Some exemplary third-party services include Philips, Samsung, Siemens, GE health clouds, etc.

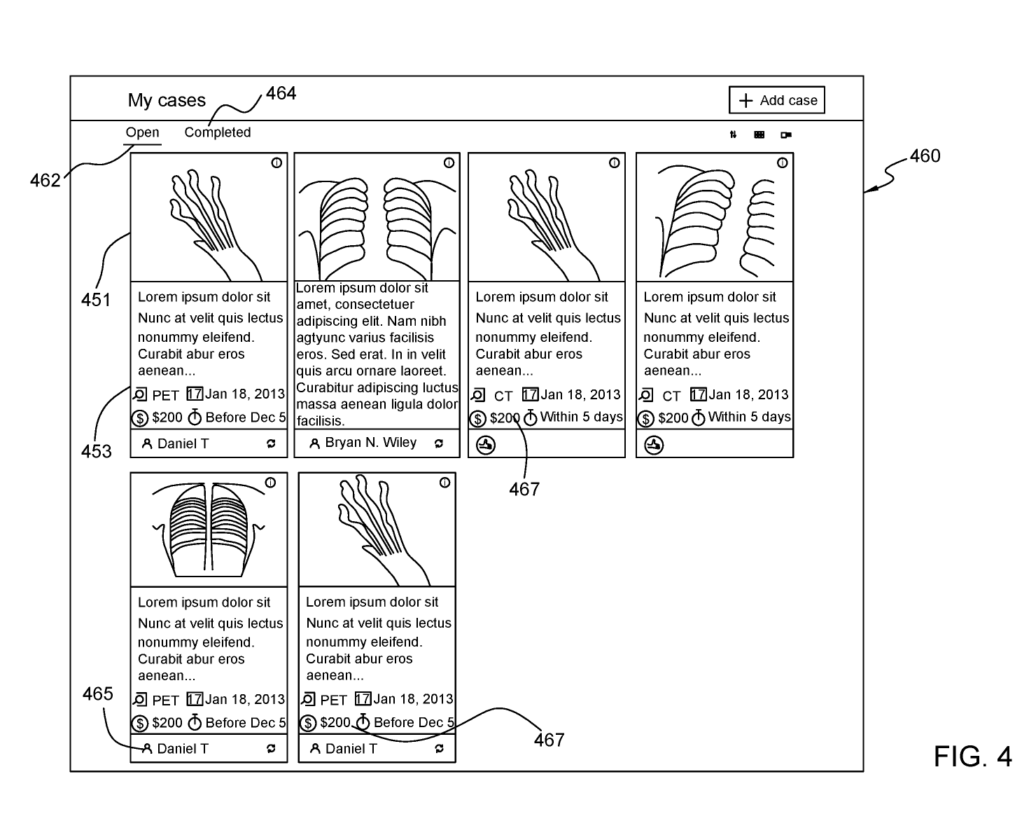

FIG. 4 shows an exemplary screenshot of the customer's home page where a customer's medical cases 460 are visible including open cases 462 and completed cases 464. In some embodiments, thumbnails 451, descriptors 453 and a price 467 of the medical cases 460 are displayed. In some embodiments, open cases may be accepted by a medical imaging expert and their name may be displayed 465. In some embodiments, open cases may be assigned to a medical imaging expert to read and the expert may choose to accept or decline the assignment. It is noted variations in the arrangement and content are contemplated and the screenshot is meant to be exemplary and non-limiting.

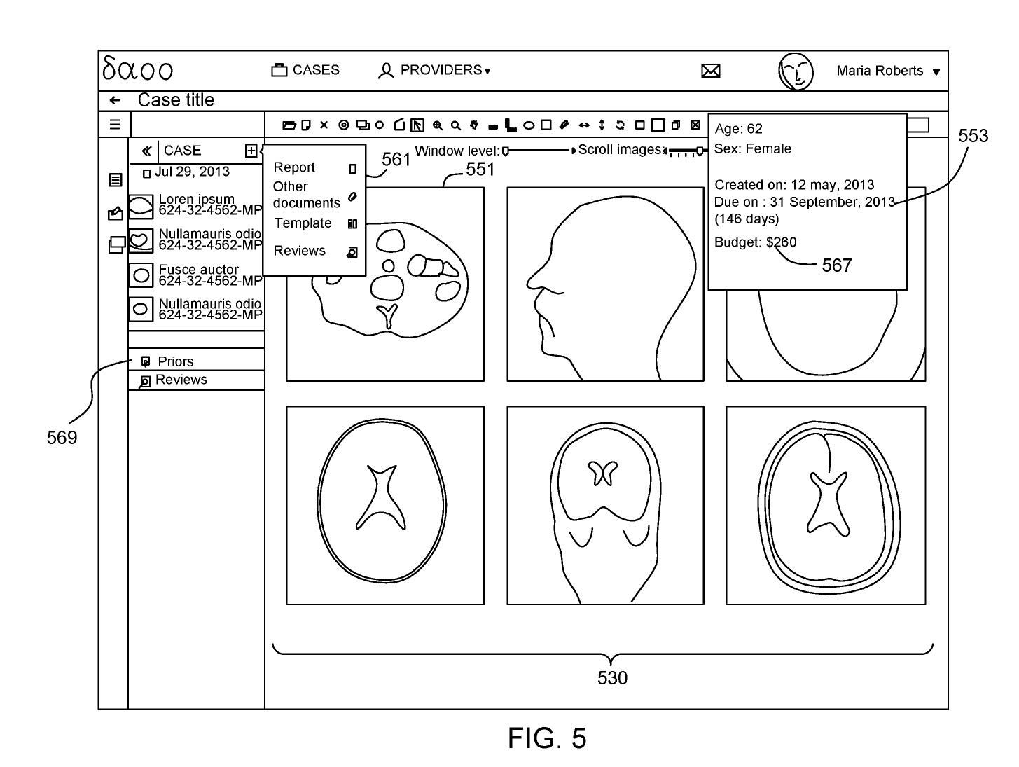

FIG. 5 shows an exemplary screenshot of the customer's medical case. As shown, the medical case includes several medical images 530. In some embodiments, thumbnails 551, case information 553 (including a budget 567), priors 569 relating to the medical case can be accessed. A menu 561 may provide access to reports, other documents, templates and reviews for that case or patient.

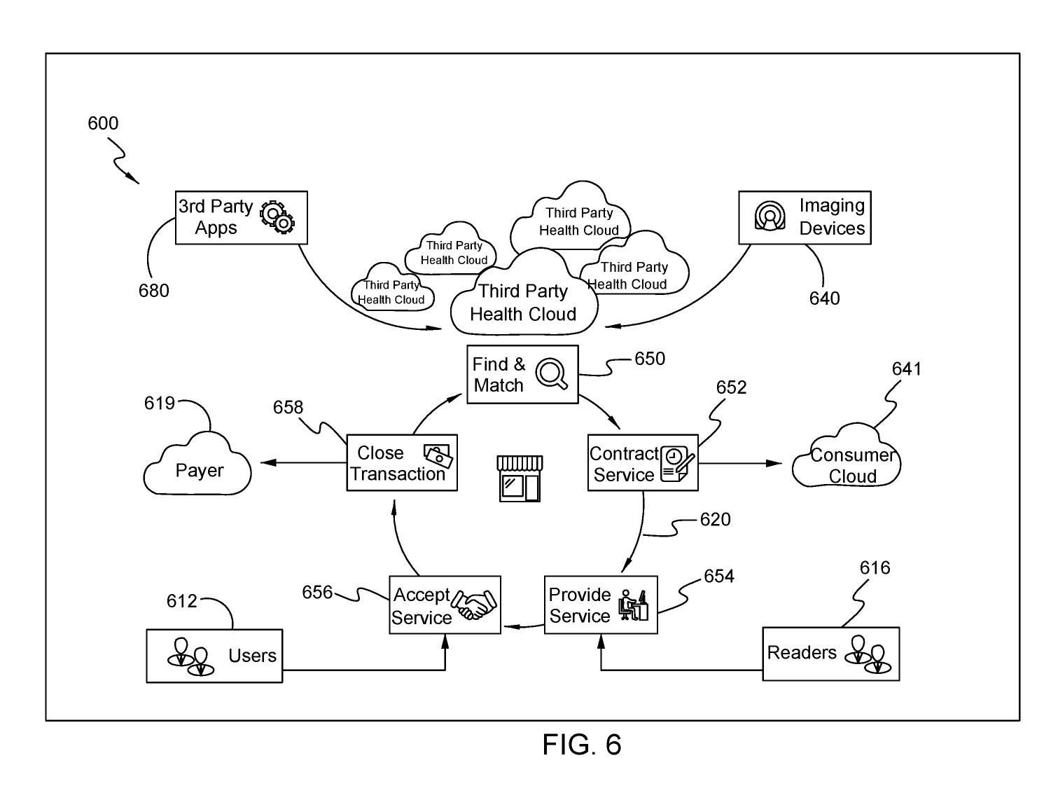

FIG. 6 is an illustration of an exemplary embodiment of a system 600 for a marketplace to obtaining medical interpretation for medical images. As shown, various participants—customers or users 612, medical imaging experts or readers 616, payers 619—can interact in the system 600 within the lifecycle of a typical image reading or medical interpretation transaction.

The back-end server 620 may provide a match chosen by customer (by assigning a medical case to an expert) and the expert accepting the assignment. The match may be made automatically using a matching algorithm and the matching algorithm may use machine learning techniques or other known techniques.

Third party applications 680 may provide access to third party cloud services (via apps 680) to the system 600, such as health clouds from GE, Siemens, Samsung, Phillips, etc. In addition, imaging devices 640 may directly route medical images to the server 620 using a DC router.

Once consumer's need and expertise matched, the customer 612 and medical imaging expert 616 may contract for performing the reading service 652. In some embodiments, contracting may be conducted on the consumer cloud 641, where the consumer cloud may include patients who are connected to various healthcare providers and need access to medical interpretation services. Then, the expert 616 may provide the reading service act 654. Then, the customers 612 may accept service for obtaining a medical interpretation for medical images 656. The transaction may be closed when the payer 619, who in some cases may be the customer 612, makes a payment or provides payment authorization 658. Then, the customer may search the back-end system find a match for the medical expertise at the right price 650.

FIG. 7 depicts the relationships 700 that various third parties may have with the back-end server 720. As shown, the server 720 may host a pricing engine 770. For examples, medical image service providers or medical imaging experts 716 may include academic radiologists 721, radiology groups 723, independent radiologists 725, etc. Free-standing imaging centers 711, health systems 713, health plans 715 may access the server 720 via a common portal 710 or dedicated portals (not shown) for customers 712. As shown, the server 720 may offer different contract types 772 based on volume, case mix, specialty or subspecialty that may that may work with the pricing engine 770. In some embodiments, the pricing engine 770 will take into account the actual 773 and Medicare pricing 775 to recommend a price (the recommended price 778) for the service. In some embodiments, the server 720 may include contract management 731, quality measures 733 and a payment gateway 735.

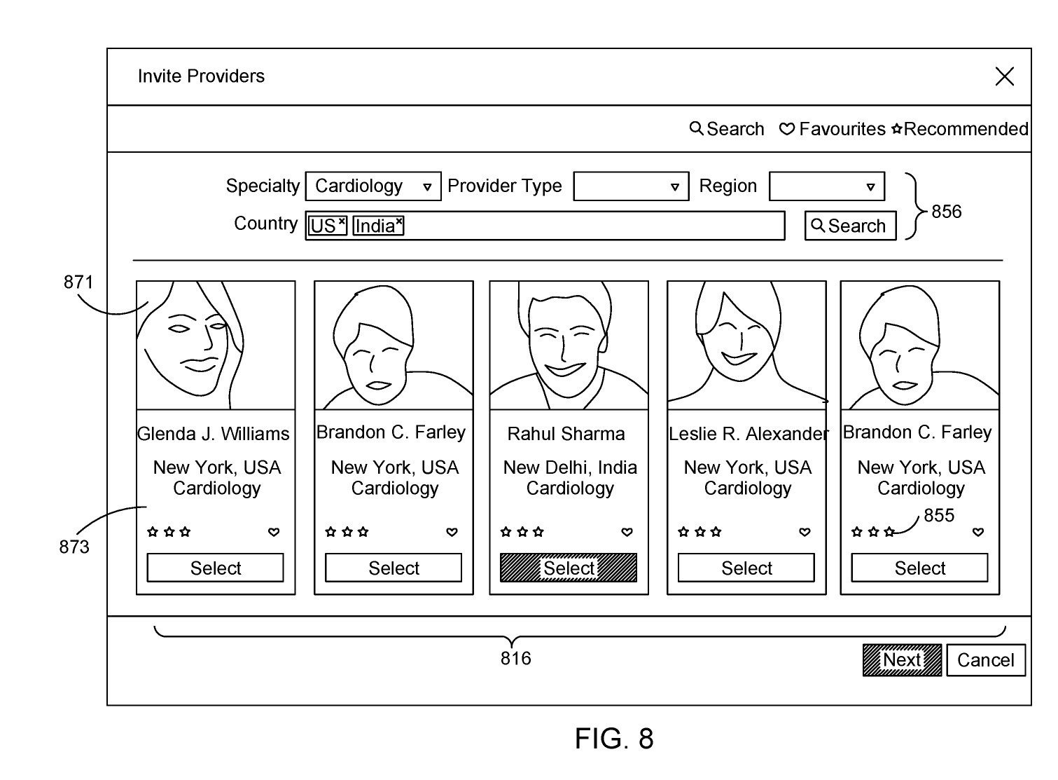

FIG. 8 shows an exemplary screenshot of the search screen for medical image service providers or medical imaging experts 816. A user-friendly and informative screen may allow a customer to find an expert that meets his or her need. As shown, a customer may search for experts based on search box 856 including search criteria such as specialty, provider type, region, country. The experts 816 located in the search are displayed with profile pictures 871 and descriptors 873. In addition, the rating 855 for the expert 816 may be displayed so that the customer can make an informed decision.

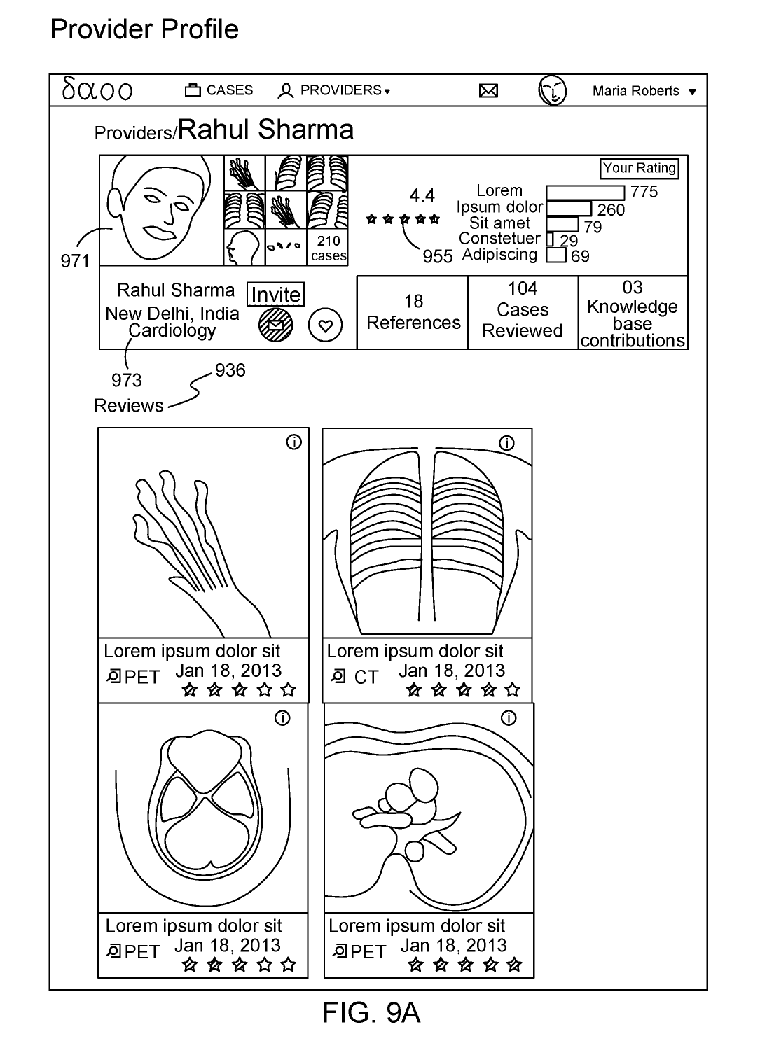

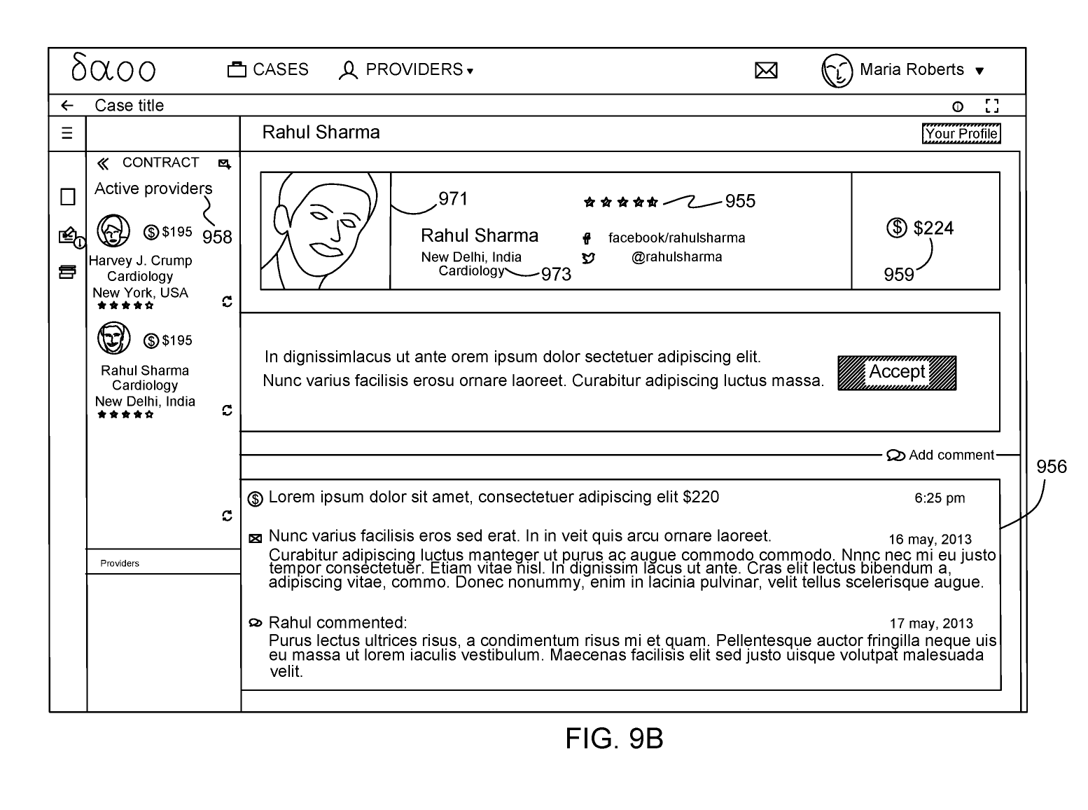

For more information, a customer may view the profile of the medical imaging expert. Exemplary screenshots of an expert's profile are shown in FIGS. 9A and 9B. In FIG. 9A, the profile includes a profile picture 971, descriptor 973, rating 955, etc. The customer may also view information about the medical cases that the expert has undertaken 936. It is noted that such comprehensive information, which is typically not available to customers may help them make informed decisions.

In addition to profile picture 971, descriptor 973, rating 955, FIG. 9B may include additional details such as a price per reading 959 and the expert's bidding, commenting or transaction history 956. In some embodiments, a list of active image service providers 958 may provide alternate experts that the customer can consult.

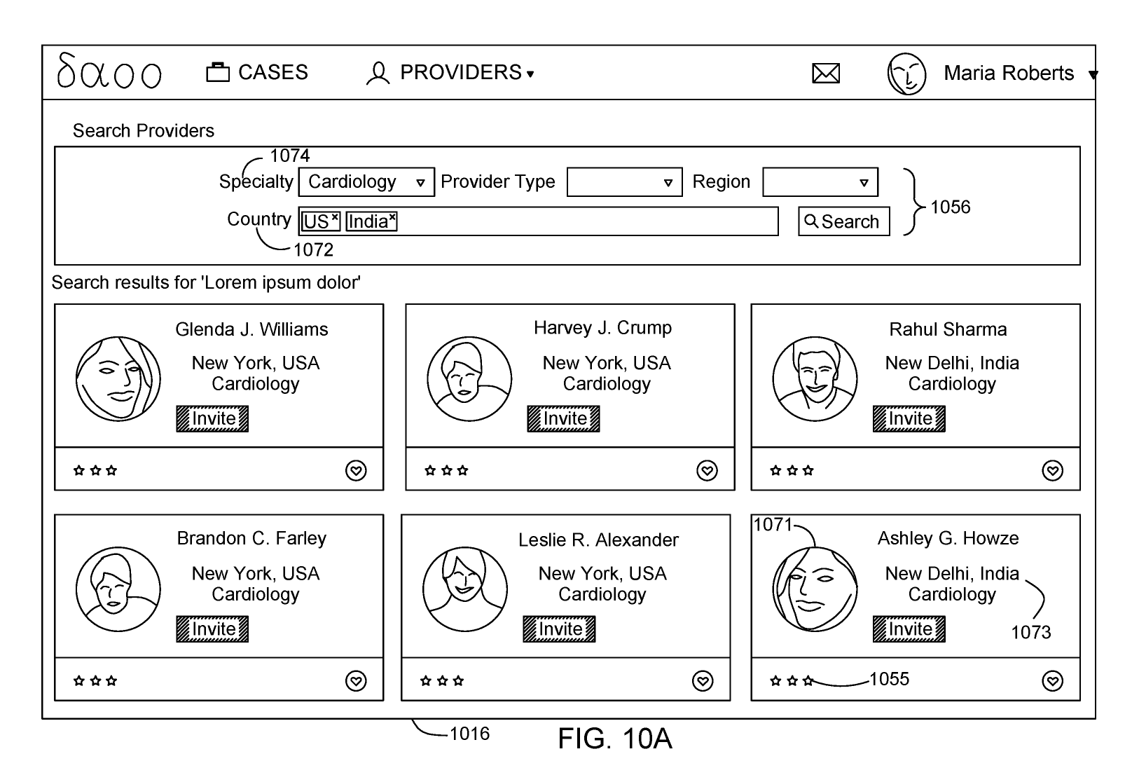

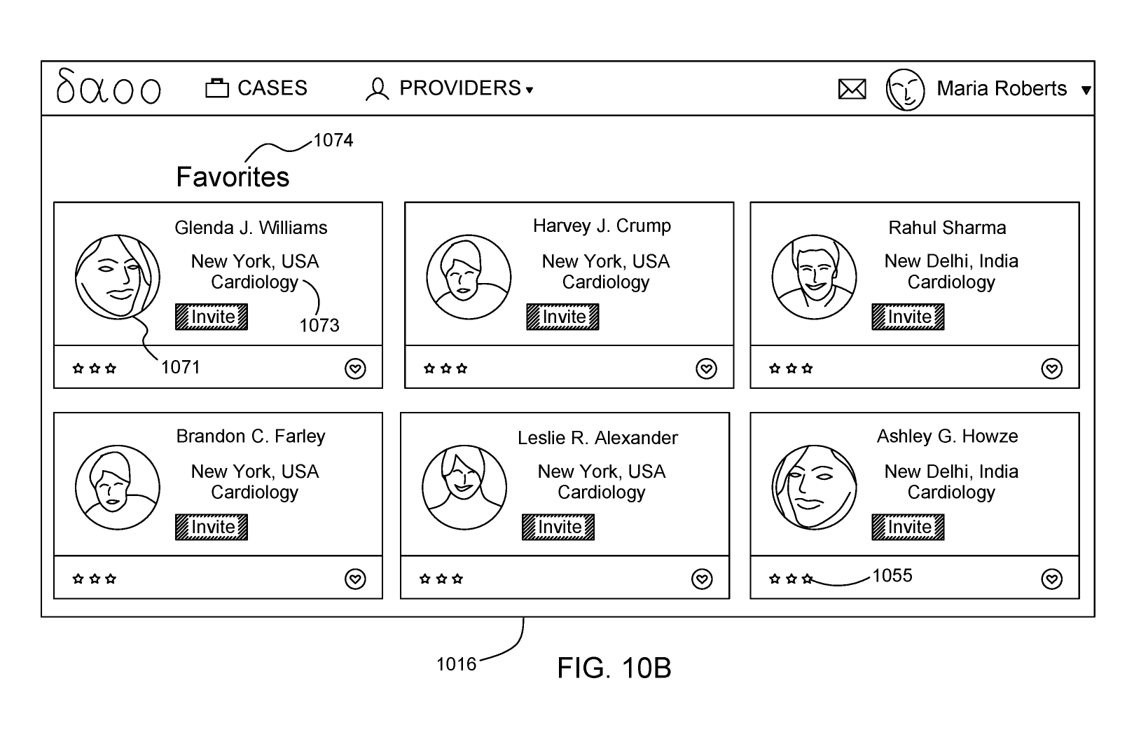

Another exemplary screenshot for searching for medical image service providers or medical imaging experts 1016 is shown in FIG. 10A. As shown, experts may be searched using exemplary search box 1056 including by specialty 1074 and country 1072. A customer may view the profile picture 1071 and descriptor 1073 the rating 1055 of the expert before choosing an expert.

However, a customer need not search for experts each time. For a customer's convenience, he or she can save some experts 1016 as favorite providers. An exemplary screenshot of favorite experts is shown in FIG. 10B. As shown, favorite providers or experts 1074 may show their profile picture 1071, descriptor 1073 and rating 1055.

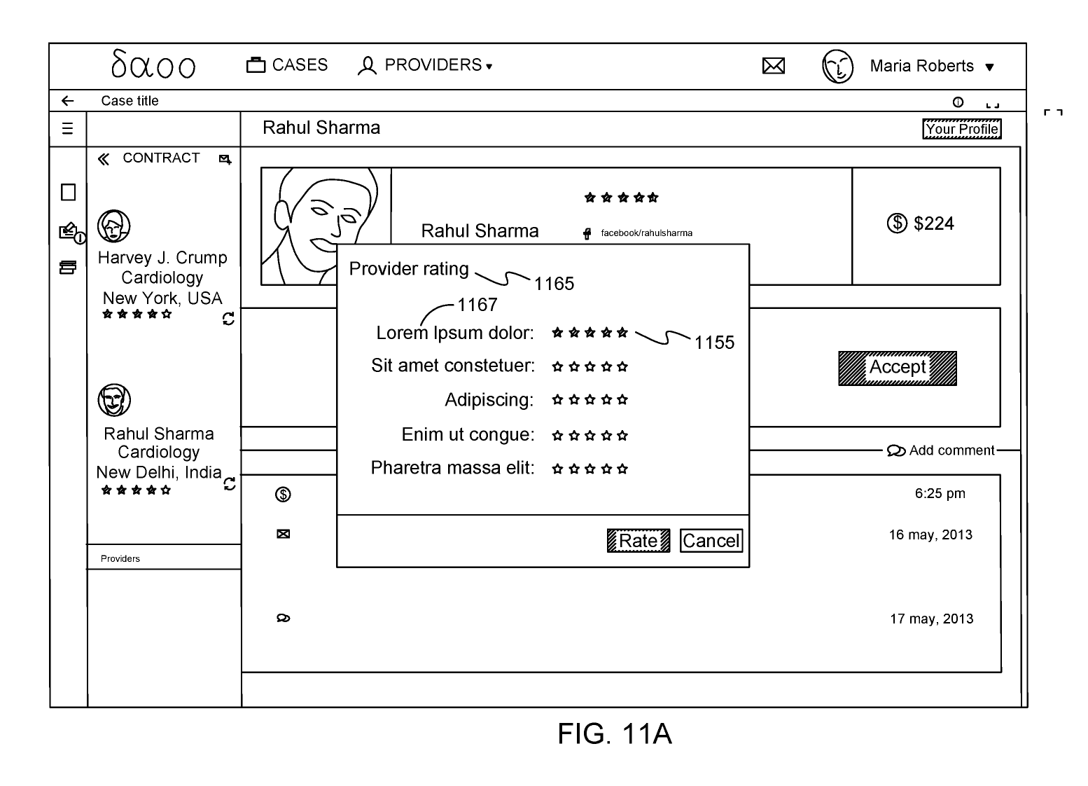

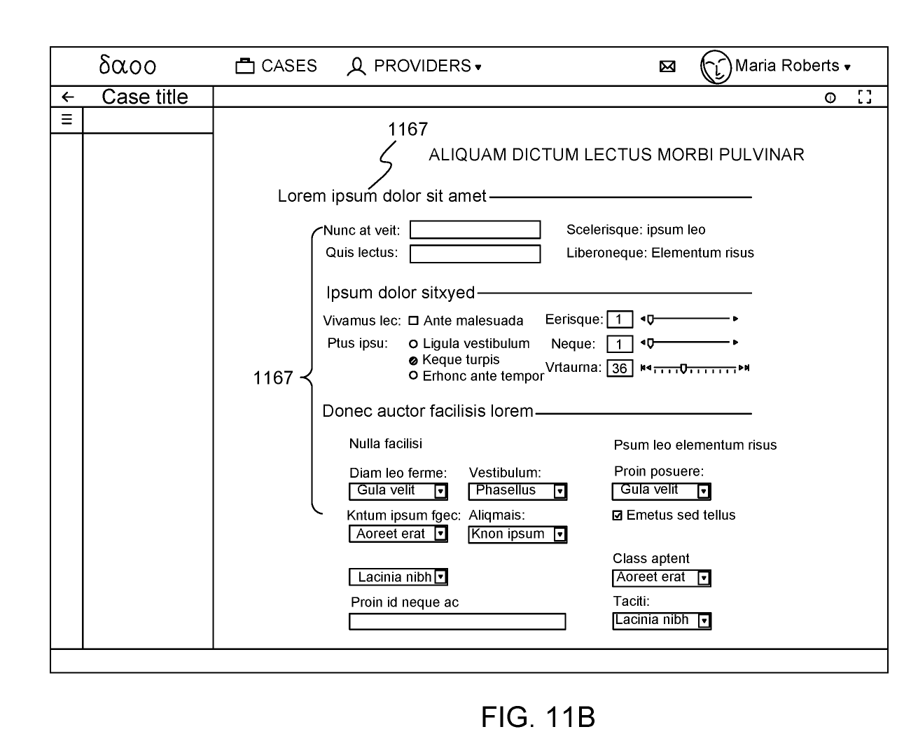

For oversight and management of the system, various participants and stakeholders such as customers, image service providers or medical experts, administrators, payers may be able to review their experience with others in the system. For example, FIGS. 11A and 11B show exemplary screenshots of the providing a review screen and another screen that may allow a participant to choose reviewing criteria 1167. As shown in FIG. 11A, a participant, such as a customer, may provide a rating 1165 for another participant, such as a provider or medical expert (referred to as the provider rating 1165). The rating may be provided as shown as five-star rating 1155. FIG. 11B shows that a participant, such as an administrator, may adjust the reviewing criteria 1167 to fit their needs.

An exemplary screenshot of a medical imaging expert or provider's home screen or dashboard 1260 is shown in FIG. 12. The dashboard 1260 includes a worklist 1262 of pending medical cases, a list of recommended cases 1264, a medical case archive 1266, and knowledgebase updates 1268 (which may include the medical imaging expert's contributions to the knowledge base or cases that may be of interest to the expert). It is noted that numerous variations for screenshot in FIG. 12 is contemplated for providing an ease-of-use and efficiency.

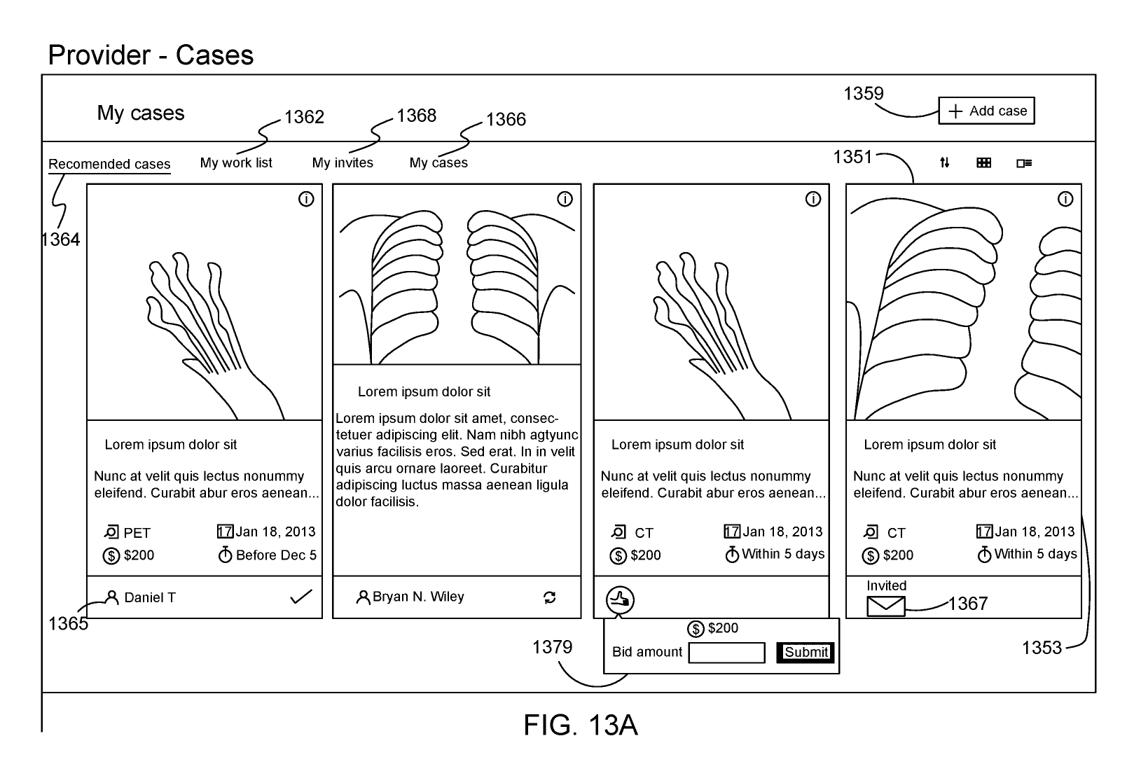

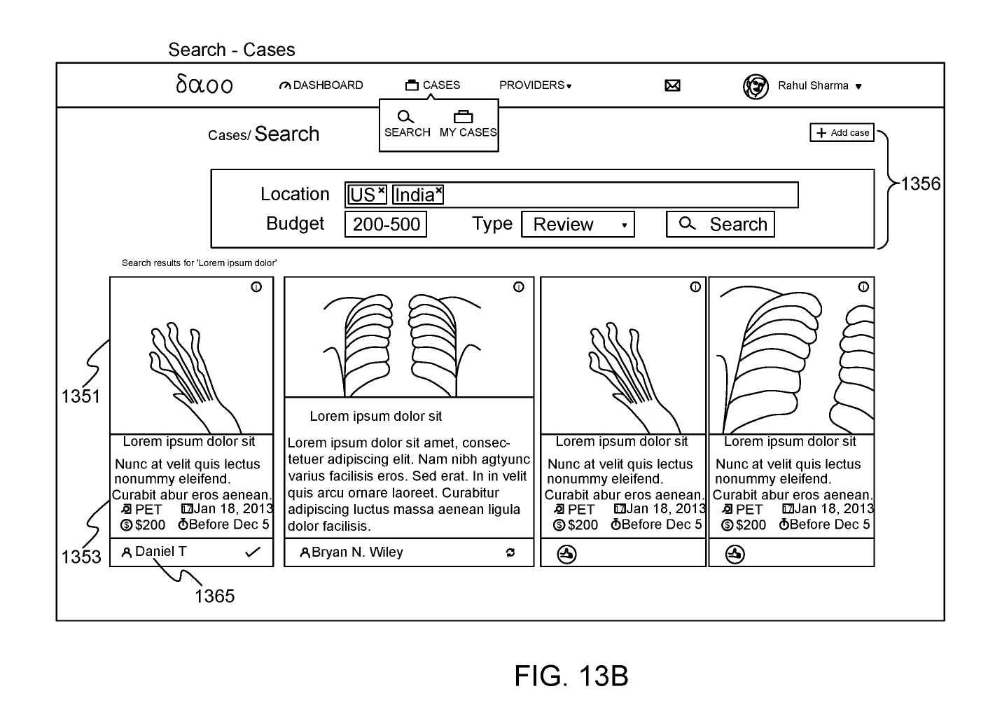

Case management features are also disclosed. FIG. 13A shows an exemplary screenshot of medical cases for a provider or a medical expert while FIG. 13B shows a screenshot for searching cases. As shown, cases may be divided into recommended cases 1364, my work list 1362, my invites 1364, my cases 1366 and new cases may be added using button 1359. As shown, the recommended cases 1364 include a thumbnail of the case 1351, short description 1353 (including patient body part, type of test or modality, deadline, price and time left for reading, etc.). Cases that have been assigned and/or accepted by medical imaging experts for providing medical interpretations may be noted by, e.g., by name or initial of expert below the medical case 1365. In some embodiments, the expert may have been invited to provide medical interpretation for a case indicated by the invitation icon 1367. The experts may bid on a case using the dialog box 1379.

In addition to recommended cases, the medical imaging expert may search for and locate cases for medical interpretation. An exemplary search box 1356 is shown in FIG. 13B. The search criteria may include location, budget, type of review, etc. The search results may include thumbnails of the cases 1351 and a short description 1353. In some cases, the search results may note the cases that have been assigned and/or accepted by medical experts as shown in 1365.

Easy-to-use features for providing medical interpretations are also disclosed. FIGS. 14A, 14B and 14C depict exemplary screenshots for providing medical interpretations. FIG. 14A shows the screen where a medical expert or provider can complete a template for a reading including reading criteria 1473. Exemplary reading criteria include procedure, reason for exam, technique, comparison, findings, impression, etc. In addition, a medical image viewer 1471, such as a DICOM viewer is also available for displaying medical images. A dictation recording may be included in the report using dictation buttons 1475. FIG. 14C shows a screen 1460 where a participant, such as the expert or customer, can adjust the reading criteria 1473 for the medical interpretation or use another reporting template.

FIG. 14B shows a screen where the expert and the customer requesting the reading can have secure communications 1476 in real-time. As shown, real-time communications between a customer 1412 and a medical imaging expert 1416 is depicted. In this way, the system provides an easy-to-use method for the medical image expert to obtain further information about the patient or medical case, which may be helpful for providing the medical interpretation quickly and efficiently.

The secure communication may be through secure instant messaging, secure real-time messaging or secure chat messaging. To maintain secure communication, the communications may be encrypted, password-protected, anonymized, etc. Proxy servers may be used for secure communication. The communications may be taking place in real-time in which participants exchange information instantly or with negligible latency. The secure communication may not occur in real-time, but by email, on a message board, and there may be significant delay between transmission and receipt of information.

The medical interpretation may be reported in various ways. In some embodiments, one or more reports are generated. Exemplary reports are shown in FIGS. 14C and 15A. As shown, the reports 1460 and 1560 can have various sections and information categories such as name and address of the medical imaging expert, patient information, medical case details (type of test, etc.), and the medical interpretation (such as indication, technique for modality, quality, description, reason for exam, conclusion, electronic signature of the medical imaging expert, etc.). The report template may be adjusted by the customer or medical expert through a template adjusting screen such as the one shown in FIG. 15B. FIG. 15B shows an exemplary screen for reporting where the reporting criteria 1573 can be adjusted to create another reporting template. A document (such as PDF) may be generated and saved electronically.

In other embodiments, the medical interpretation may be exported to the customer's EMRs through the APIs (such as Exporting Reading Results API 146 in FIG. 1). The medical interpretation may be provided to the customer in an email or other form of notification such as text message, instant message, chat message, voice message, etc.

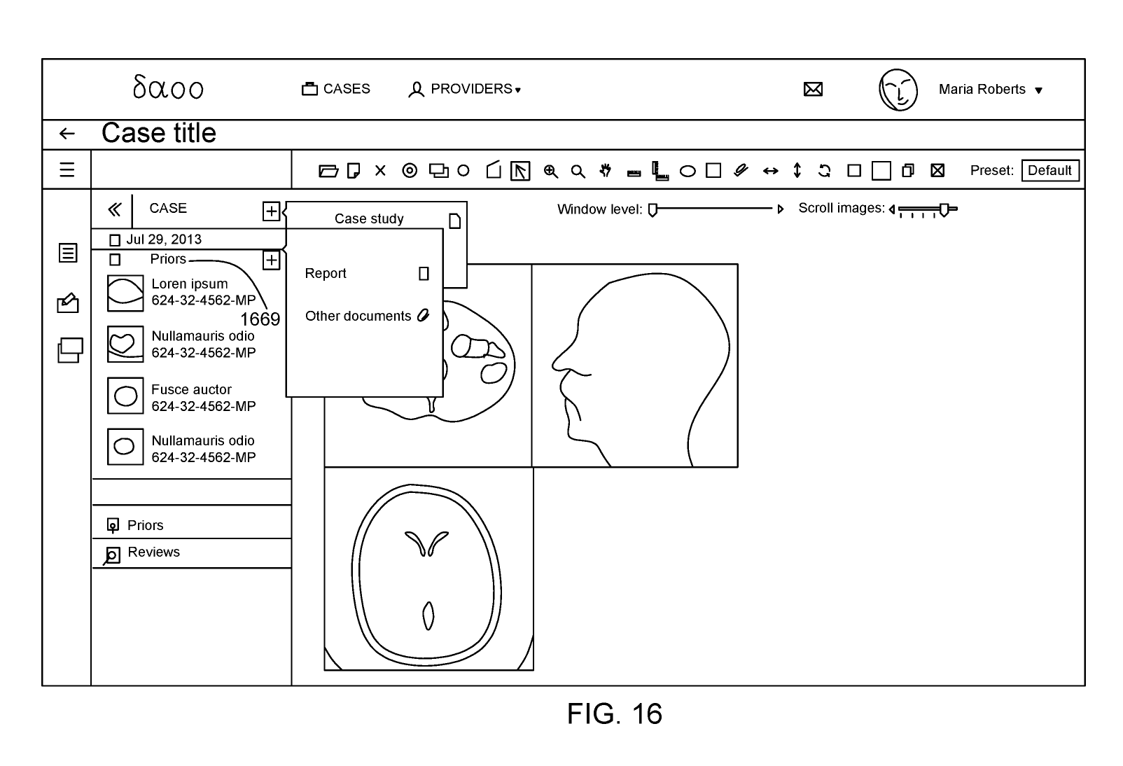

In some cases, the medical experts or provider may find it helpful to review prior studies 1669 for the same patient to evaluate progression of the disease or healing. “Priors” or “prior studies” include longitudinal medical reports of the same patient used for comparing medical images taken at different times. An exemplary screenshot of prior studies is depicted in FIG. 16.

A system for credentialing medical imaging experts may include an image service provider portal wherein a medical imaging expert initiates the credentialing process by providing profile information comprising one or more credentials; an administrative portal wherein an administrator manages the credentialing process and obtains verification record of the credentials of the medical imaging experts; and a back-end server that stores the profile information and verification record of the medical imaging experts, wherein the back-end server comprises a medical passport module for on-boarding medical imaging experts by verification of one or more credentials, such as Board certifications, state licensure, subspecialties, etc. Profile information including credentials may be provided by the medical imaging experts, administrators or other participants using an exemplary screen shown in FIG. 17A. As shown, a profile picture 1771 of the medical imaging along with credentials 1770 (such as board certifications, state licensure, clinical experience), location information (not marked), work history 1776 may be included. It is noted that an exemplary and non-limiting example of a medical imaging experts profile is shown and numerous variations are contemplated.

The credentials of the medical imaging experts are checked when they login to the image service provider portal. Experts with inactive credentials may be restricted from certain activities to maintain the high-quality of the services. For example, the medical imaging experts are available for providing final medical interpretations of medical images after on-boarding onto the system by verification of one or more credentials. Customers may also view the credential verification status of one or more credentials of medical imaging experts before providing medical images for medical interpretation.

FIG. 17B shows an exemplary administrator's screen for checking the credential status of medical experts and providers. In addition, the administrator may oversee or participate in creating a verification record for the credentials for medical experts. As shown, the administrator's screen may include the creation date of the 1782 certification 1786, the name of the radiologist (not marked), the primary sources of credentials 1788 (such as websites), the type of verification 1792, the expiration of the credentials 1782, and a link for details 1784. The link for details 1784 may include the verification record of the credentials, which may be a screenshot or printout checking the status of a medical expert's credentials. For example, the verification record may be from the result of a last name search for a doctor on a primary source website. In some embodiments, independent third-party verifies primary sources for the credentials of the medical imaging experts. The verification record may provide an auditing trail for the on-boarding experts on to the system by verification of one or more credentials (such as state licensure, board certifications, clinical expertise, etc.). The screenshot or printout may be uploaded onto the system by the administrator or another participant in the system.

Obtaining credential verification may be accomplished in a variety of ways including a status check of the professional licensing, board certifications, or state licensing of the medical imaging expert. Obtaining a verification record may be completed by an independent third-party by verifying primary sources for the credentials of the medical imaging experts. Obtaining a verification record may also be completed by the medical imaging expert or image service provider, such as by uploading certificates or verification status check records. The oversight responsibilities of the administrator may require a manual review by the administrator for obtaining a verification record. In some cases, the administrator may override the step of obtaining a verification record in a limited number of situations, e.g., for educational consultations, blind evaluations, clinical trials, etc.

A system for providing medical interpretation may include a healthcare service provider portal wherein a health care service provider uploads medical images. The system may further include a medical image service provider portal wherein a medical imaging expert may access a medical image, and a back-end server that stores the medical images and acts as a communication conduit between a health care service provider and a medical image service provider.

The system may include a medical image service provider profile comprising one or more details such as total reads provided, types of reads provided, contribution to the knowledge base, examples of cases read including reports (without the PHI), credential verification status, verified account, institution and/or subspecialty. In some embodiments, the system includes a medical image service provider profile, wherein the profile may be designated as a favorite. In some embodiments, the health care service provider and the medical imaging expert can have secure communications using the system. The medical image service provider may have been on-boarded onto the system by verification of one or more credentials. The medical images may be assigned to one or more medical image service providers using a matching algorithm. The system may allow health care service providers to review medical image service providers. The system may include a bidding engine that allows medical image service providers to bid on the task of reading medical images. The system may create a knowledge base based on medical images uploaded to the system over time. The system may include a malpractice component wherein each medical image reading is covered by a specific malpractice policy.

While the embodiments described above are generally directed to radiologists and pathologists providing readings of medical images such as radiographs, the present disclosure is not so limited and may be applicable to other experts such as physical therapists for evaluating injury, healing, and the effect of treatment by evaluating current and prior radiographs. In some embodiments, the experts may be dentists who may evaluate dental X-rays for, e.g., removal of wisdom teeth. In some embodiments, experts may be non-medical experts such as engineers who use x-rays for inspection of industrial parts and welds.

Moreover, while specific embodiments may have been illustrated and described collectively herein, it should be appreciated that any subsequent arrangement designed to achieve the same or similar purpose may be substituted for the specific embodiments described and shown herein. This disclosure is intended to cover any and all subsequent adaptations or variations of various embodiments. Combinations of the above embodiments, and other embodiments not specifically described herein, will be apparent to those of skill in the art upon reviewing the description.

Other embodiments of the present disclosure will be apparent to those skilled in the art from consideration of the specification and practice of the embodiments disclosed herein. It is intended that the specification and examples be considered as exemplary only, and departure in form and detail may be made without departing from the scope and spirit of the present disclosure as defined by the following claims.

What is claimed is:

1. A system for obtaining a medical interpretation for medical images comprising:
a customer portal wherein a customer uploads one or more medical images, wherein one or more medical images comprise a medical case;
an image service provider portal wherein a medical imaging expert accesses the medical case and provides the medical interpretation; and
a back-end server that stores the medical case, wherein the server
provides access to a marketplace for obtaining the medical interpretation, and
acts as a real-time communication conduit between the customer and the medical imaging expert.

2. The system of claim 1 further comprising one or more databases for storing the medical images.

3. The system of claim 1, wherein the medical images are uploaded by routing the medical images via a Direct Connect (DC) Gateway.

4. The system of claim 1, wherein credentials of the medical imaging experts are checked when the medical experts login to the image service provider portal.

5. The system of claim 1, wherein the medical image service provider has been on-boarded onto the system by verification of one or more credentials.

6. The system of claim 1, wherein the medical case is assigned to one or more medical imaging experts automatically using a matching algorithm comprising machine learning techniques.

7. The system of claim 1, wherein the medical case is assigned to one or more medical imaging experts using a matching algorithm.

8. The system of claim 1, wherein the medical imaging expert who has accepted the medical case may have secure communications in real-time with the customer requesting the medical interpretation.

9. The system of claim 1, wherein the system creates a knowledge base based on medical images uploaded to the system over time.

10. The system of claim 1, wherein the system allows customers to review medical imaging experts.

11. The system of claim 1, further comprising a bidding engine that allows customers to bid on services of medical imaging experts.

12. The system of claim 1 further comprising a malpractice component wherein a malpractice insurance is provided on a per case basis for the services of the medical imaging experts.

13. A process for obtaining a medical interpretation comprising:
(a) a customer uploads one or more medical images through a customer portal and accesses a marketplace for obtaining the medical interpretation the one or more medical images, wherein the one or more medical images comprise a medical case;
(b) a medical imaging expert with verified credentials accesses the medical case through a medical image service provider portal and provides the medical interpretation; and
(c) a report is generated in a back-end server based on the medical interpretation and shared with the customer.

14. The process of claim 13 further comprising storing the medical images in one or more databases in the back-end server.

15. The process of claim 13, wherein the medical images are uploaded by routing the medical images via a Direct Connect (DC) Gateway and stored in one or more databases in the back-end server.

16. The process of claim 13, wherein the medical imaging expert who has accepted the medical case may have secure communications in real-time with the customer requesting the medical interpretation.

17. The process of claim 13, wherein a knowledge base based on medical images in the back-end server over time.

18. The process of claim 13, wherein the back-end server allows customers to review medical imaging experts.

19. The process of claim 13 further comprising a bidding engine that allows customers to bid on services of medical imaging experts.

20. The process of claim 13, wherein the credentials of the medical imaging expert have been verified by checking primary sources.
